(19) United States
(12) Patent Application Publication
(10) Pub. No.: US 2026/0017549 A1
(43) Pub. Date: Jan. 15, 2026

(54) QUANTUM CIRCUIT FOR IMPLEMENTING THE DISCRETE-VARIABLE REPRESENTATION TRANSFORMATION AND METHODS FOR USE THEREWITH

(71) Applicant: BEIT Sp. z o.o., Kraków (PL)

(72) Inventors: Emil Zak, Kraków (PL); Szymon Zdzislaw Plis, Kraków (PL)

(73) Assignee: BEIT Sp. z o.o., Kraków (PL)

(21) Appl. No.: 19/262,305

(22) Filed: Jul. 8, 2025

Related U.S. Application Data
(60) Provisional application No. 63/669,814, filed on Jul. 11, 2024.

(51) Int. Cl. G06N 10/20; G06N 10/60

(52) U.S. Cl. CPC G06N 10/20; G06N 10/60

(57) ABSTRACT

A quantum oracle, configured to implement a discrete-variable representation (DVR) matrix, operates by: loading a first column of the DVR matrix via a quantum random access memory oracle; recursively loading an additional N−1 columns of the DVR matrix via an alternating sequence of unitary circuits operating on a first set of qubits and a second set of qubits controlled via a column index; and transferring states of the first set of qubits and the second set of qubits to a quantum register controlled by a parity of the column index.

### CROSS REFERENCE TO RELATED APPLICATIONS

The present U.S. Utility patent application claims priority pursuant to 35 U.S.C. § 119(e) to U.S. Provisional Application No. 63/669,814, entitled “QUANTUM CIRCUIT FOR IMPLEMENTING THE DISCRETE-VARIABLE REPRESENTATION TRANSFORMATION AND METHODS FOR USE THEREWITH”, filed Jul. 11, 2024, which is hereby incorporated herein by reference in its entirety and made part of the present U.S. Utility patent application for all purposes.

### BACKGROUND OF THE INVENTION

### Technical Field of the Invention

This invention relates generally to computer systems and particularly to quantum computing techniques and circuits.

### Description of Related Art

Computing devices are known to communicate data, process data, and/or store data. Such computing devices range from wireless smart phones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a block diagram of an example of a quantum computing architecture;

FIG. 1B is a block diagram of an example of a quantum oracle;

FIG. 1C is a flow diagram of an embodiment of a method;

FIG. 2A is a block diagram of an example of a quantum oracle; and

FIGS. 2B-2F are block diagrams representing components of a quantum oracle.

### DETAILED DESCRIPTION OF THE INVENTION

FIG. TA is a block diagram of an example of a quantum computing architecture. In particular, a quantum circuit 110 is presented that includes a quantum oracles 112, and/or one or more other quantum logic gates 116 that operate on m qubits of a quantum register 120. The quantum oracle, which may also be referred to as “oracle operator”, “oracle function”, “unitary circuit”, or simply “oracle” is a black box that performs a quantum operation on an input quantum state either with, or without, the aid of additional ancillas. It should be noted that a quantum oracle can itself contain other unitary circuits/oracles as components/building blocks. Quantum oracles can play a fundamental role in quantum algorithms by providing a way to manipulate quantum states and perform computations that are not possible with classical computers.

In various examples, the action of the quantum oracle on a specific quantum state can be found by multiplying an input vector, which represents the input qubit state, by a matrix transformation (or simply “matrix”) representing the particular function being implemented. The result is a new quantum vector state. Most generally, the input vector state can be represented most by:

$$\vert {ψ}_{1} 〉$$

And the output vector state can be represented most by:

$$\vert {ψ}_{2} 〉$$

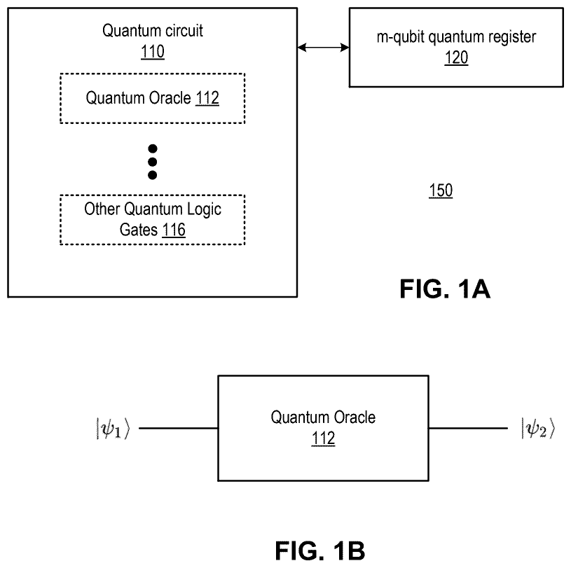

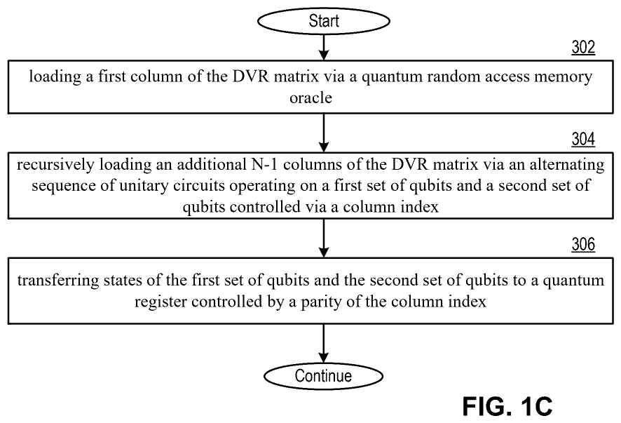

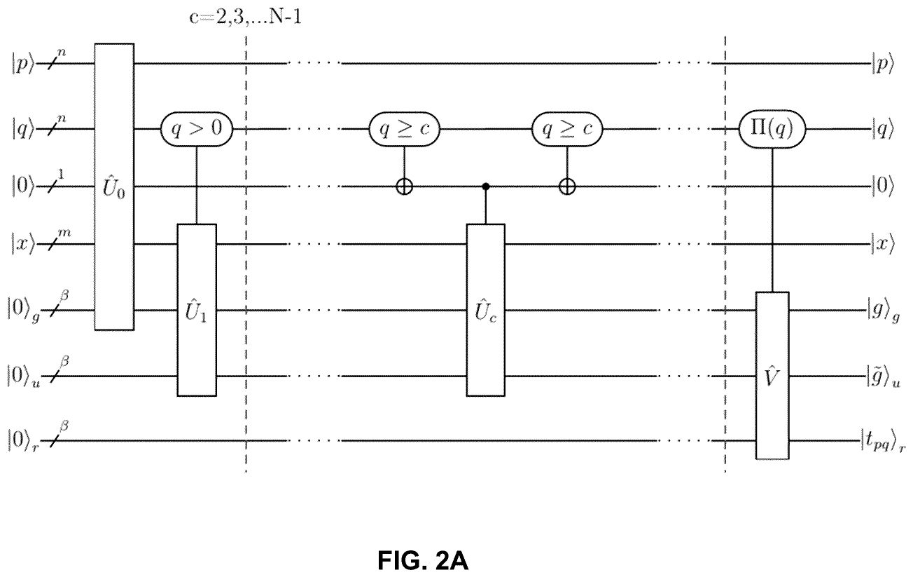

As shown in FIG. 1B.

In various examples, the quantum oracle 112 is configured to encode matrix elements of a unitary transformation that is based on a discrete-variable representation (DVR) matrix/transformation into qubit states. The DVR technique, introduced by Harris and further developed by Light et al. is widely used in computational physics, simulation, and engineering. The DVR's core principle involves representing eigenvalue problems in a localized basis, leading to diagonal local quantum mechanical operators. This technique has been successfully applied in various research fields, including space engineering, exoplanet spectroscopy, quantum dynamics simulations, and attosecond physics.

In the context of quantum mechanics, DVR utilizes basis sets of orthogonal polynomials that solve the Schrödinger equation for specific model systems, including but not limited to:
Hermite polynomials for the Harmonic oscillator;
Laguerre polynomials for the Hydrogen atom;
Associated Laguerre polynomials for the Morse oscillator;
Chebyshev polynomials for the particle in a square potential well;
Legendre polynomials for spherical symmetry problems; and
Lobatto polynomials for fixed boundary conditions.

A component of DVR is the transformation matrix T, which transitions from the finite-basis representation (e.g., variational basis) to the discrete variable representation. This transformation is based on a Gaussian quadrature scheme using orthogonal polynomials, with quadrature grid points x and weights w. By definition, the DVR transformation matrix diagonalizes the position operator in quantum mechanics, giving fast convergence in finding eigenvalues of many-body Hamiltonians, even for complex potential energy functions.

DVR stands out from other finite element methods due to its use of the N-point Gaussian quadrature derived from orthogonal polynomials. The unitary nature of the DVR transformation makes it particularly suitable for quantum computing applications. In Hamiltonian simulations, the DVR representation ensures a diagonal potential matrix, with entries corresponding to the potential values at grid points. DVR can be viewed as a generalization of the Fourier transform, with quantum-DVR (QDVR) serving as a generalization of the Quantum Fourier Transform (QFT). This generalization suggests that the DVR can significantly impact quantum computing simulations, particularly in Hamiltonian simulation on fault-tolerant quantum computers.

For multi-dimensional problems, a direct-product DVR is employed, where the multi-dimensional transformation is a tensor product of single-dimensional transformations. The computational cost (memory) for performing this transformation on classical computers scales exponentially with the number of dimensions, N^{D}, where N is the number of basis functions per dimension and D is the number of dimensions. Quantum computers, however, reduce this memory complexity to O(ND), making DVR transformations highly efficient, provided that an appropriately efficient implementation is found.

In various examples, the quantum oracle 112 can be a building block for circuits simulating Hamiltonian eigenvalues within the DVR method. In various examples, the quantum oracle 112 is constructed to exploit the recursive properties of orthogonal polynomials that define the DVR transformation. In various examples, the quantum oracle 112 performs the recursive operations composing the DVR matrix via arithmetic operations of addition and multiplication implemented via a quantum computer—without using the quantum-Fourier transform approach and instead, using a bit-by-bit adder. While the quantum oracle 112 can function as a DVR oracle generally, the quantum oracle 112 can in further examples, more specifically provide a specific realization of the DVR transformation based on Gauss-Hermite quadrature.

In various examples, the quantum oracle 112 (which can also be called a “DVR oracle”) is implemented via a quantum circuit that includes:
a quantum random access memory oracle configured to load a first column of the DVR matrix;
an alternating sequence of unitary circuits operating on a first set of qubits and a second set of qubits controlled via a column index configured to recursively load an additional N−1 columns of the DVR matrix; and
a quantum register controlled by a parity of the column index configured to loads states of the first set of qubits and the second set of qubits.

In addition or in the alternative to any of the foregoing, the DVR matrix is based on a Gauss-Hermite quadrature, a Laguerre quadrature, a Jacobi quadrature, Legendre quadrature or a Chebyschev quadrature of the first kind.

In addition or in the alternative to any of the foregoing, the alternating sequence of unitary circuits include first unitary circuits for odd values of the column index.

In addition or in the alternative to any of the foregoing, the alternating sequence of unitary circuits include second unitary circuits for even values of the column index that differ from the first unitary circuits.

In addition or in the alternative to any of the foregoing, the alternating sequence of unitary circuits perform a sequence of arithmetic unitary operations.

In addition or in the alternative to any of the foregoing, the alternating sequence of unitary circuits perform the sequence of arithmetic unitary operations via a corresponding sequence of recursion steps.

In addition or in the alternative to any of the foregoing, the alternating sequence of unitary circuits perform the sequence of arithmetic unitary operations without quantum-Fourier transforms.

In addition or in the alternative to any of the foregoing, the alternating sequence of unitary circuits perform the sequence of arithmetic unitary operations via bit-by-bit adders.

In addition or in the alternative to any of the foregoing, the DVR matrix corresponds to a transformation matrix T.

In addition or in the alternative to any of the foregoing, the transformation matrix T transitions from a finite-basis representation to the discrete-variable representation.

In addition or in the alternative to any of the foregoing, the quantum oracle is utilized to construct a unitary circuit transforming a finite-basis representation to the discrete-variable representation.

Various examples disclosed herein improve on the technology of quantum computing by providing a DVR oracle, for which the fault-tolerant quantum resources, counted as the product of the number of qubits and the Toffoli gates are smaller than other methods of unitary synthesis. In particular, various examples disclosed herein support the implementation of a DVR oracle that uses merely [symbol] (Nβ²) Toffoli gates on [symbol] (β) ancilla qubits, where N×N is the size of the DVR matrix and beta is the precision of matrix elements.

FIG. 1C is a flow diagram of an example method. In particular, a method is presented for use in a quantum circuit configured to process n qubits and d additional qubits and furthermore for use with one or more functions and features described in conjunctions with FIGS. 1A and 1B and/or the further descriptions below. Step 302 includes loading a first column of the DVR matrix via a quantum random access memory oracle. Step 304 includes recursively loading an additional N−1 columns of the DVR matrix via an alternating sequence of unitary circuits operating on a first set of qubits and a second set of qubits controlled via a column index. Step 306 includes transferring states of the first set of qubits and the second set of qubits to a quantum register controlled by a parity of the column index.

In addition or in the alternative to any of the foregoing, the DVR matrix is based on a Gauss-Hermite quadrature, a Laguerre quadrature, a Jacobi quadrature, Legendre quadrature or a Chebyschev quadrature of the first kind.

In addition or in the alternative to any of the foregoing, the alternating sequence of unitary circuits include first unitary circuits for odd values of the column index.

In addition or in the alternative to any of the foregoing, the alternating sequence of unitary circuits include second unitary circuits for even values of the column index that differ from the first unitary circuits.

In addition or in the alternative to any of the foregoing, the alternating sequence of unitary circuits perform a sequence of arithmetic unitary operations.

In addition or in the alternative to any of the foregoing, the alternating sequence of unitary circuits perform the sequence of arithmetic unitary operations via a corresponding sequence of recursion steps.

In addition or in the alternative to any of the foregoing, the alternating sequence of unitary circuits perform the sequence of arithmetic unitary operations without quantum-Fourier transforms.

In addition or in the alternative to any of the foregoing, the alternating sequence of unitary circuits perform the sequence of arithmetic unitary operations via bit-by-bit adders.

In addition or in the alternative to any of the foregoing, the DVR matrix corresponds to a transformation matrix T.

In addition or in the alternative to any of the foregoing, the transformation matrix T transitions from a finite-basis representation to the discrete-variable representation.

In addition or in the alternative to any of the foregoing, the quantum oracle is utilized to construct a unitary circuit transforming a finite-basis representation to the discrete-variable representation. In this fashion, the quantum oracle loads the matrix elements as a part of a larger unitary circuit that multiplies the quantum state by the matrix.

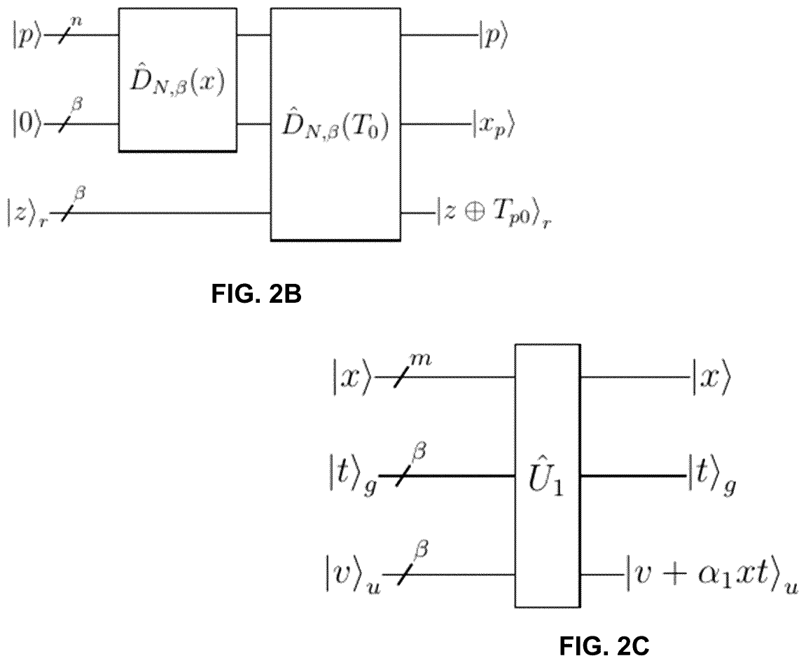

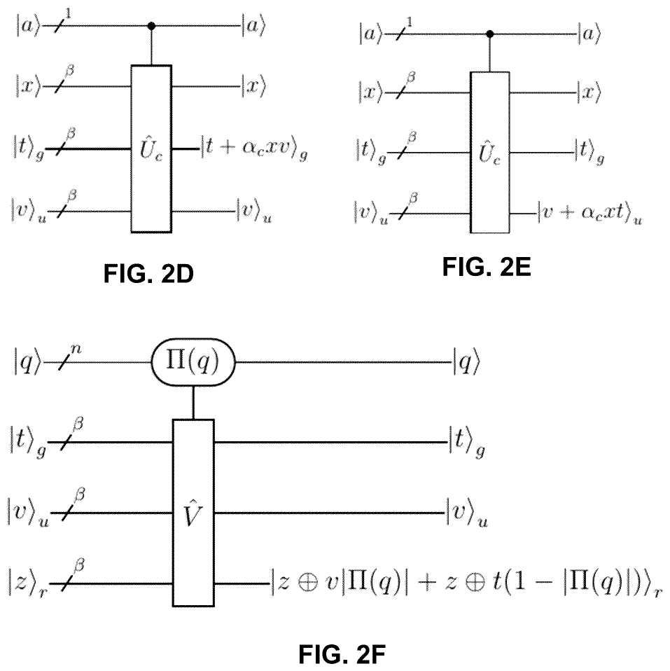

In addition or the alternative to any of the foregoing description presented in conjunctions with FIGS. 1A-1C, also consider the following examples that include additional/alternative features, functions and implementations described in conjunction with FIGS. 2A-2F presented below.

Consider a discrete-variable representation (DVR) oracle as following unitary transformation:

$$\hat{T} \vert p 〉 \vert q 〉 \vert 0 〉 = \vert p 〉 \vert q 〉 \vert {T}_{pq} 〉 \qquad ( 1. )$$

where p,q=0, 1, 2, . . . , N−1 and T_pq are real numbers. The task is therefore to load

$$\frac{N ( N - 1 )}{2}$$

numbers of length β (precision) on a quantum computer. While other techniques are implemented using [symbol] (N\sqrt{β}) Toffoli gates on [symbol] (N\sqrt{β}) ancilla qubits, various examples presented instead use [symbol] (Nβ²) Toffoli gates on [symbol] (β) ancilla qubits. Various examples presented herein thus generate a quantum volume (the number of qubits multiplied by the number of Toffoli gates) of [symbol] (Nβ³), as compared to the quantum volume of [symbol] (N²β) given by other methodologies. For the cases where N>>β² the various examples presented herein improve the technology of DVR oracles by requiring fewer quantum resources.

FIG. 2A is a block diagram of an example of a quantum oracle 112. Subscript qubit indices g and u denote ‘gerade’ and ‘ungerade’, respectively, marking the parity of the column constructed in a given recursive step. Subscript r denotes the ‘result’ register, where the final matrix element of the DVR matrix is loaded/dumped. The DVR transformation matrix elements can be generated utilizing recurrence relations of orthogonal polynomials, upon which the transformation is based. In a general case, the recurrence relation defining the DVR matrix elements can be written as:

$${T}_{pq - 2} ( x ) = x {α}_{q + 2} {T}_{p q + 1} ( x ) + ( {ϕ}_{q + 2} {T}_{pq} ( x ) \qquad ( 1.1 )$$

where α_{q}ϕ_{q} are real-valued coefficients defining the recurrence relation, ϕ_{q} are real-valued coefficients defining the recurrence relation, x∈R^{N} is a real-valued vector of quadrature nodes. Assume that the number of quadrature nodes that label rows of the DVR matrix equals the number of columns (basis functions) in the matrix. The form given in eq. (1.1) can be recast into a normalized form given by:

$${T}_{pq + 2}^{′} ( x ) = {γ}_{q + 2} {T}_{pq + 2} ( x ) \frac{{γ}_{q + 2}}{{γ}_{q + 1}} {α}_{q - 2} {T}_{pq + 1}^{′} ( x ) + {T}_{pq}^{′} ( x ) \qquad ( 1.2 )$$

where γ₀=γ₁=1, and γ_{q}=(ϕ_{q}−2ϕ_{q-4} . . . ϕᵢ)⁻¹, where i=2,3 carries the parity of q. This rescaling of the matrix elements results in a new transformation \hat{T}=Γ\hat{T}′, where:

$$Γ \vert q 〉 \vert a 〉 \vert 0 〉 = \vert q 〉 \vert a 〉 \vert {γ}_{q}^{- 1} a 〉 . \qquad ( 1.3 )$$

Minding the above definitions we implement the DVR oracle in following form:

$$\hat{T} \vert p 〉 \vert q 〉 \vert x 〉 \vert 0 〉 \vert 0 〉 = \vert p 〉 \vert q 〉 \vert x 〉 \vert {T}_{pq} ( x ) 〉 \vert g 〉 \qquad ( 1.4 )$$

where |g [symbol] stands for ‘garbage’ register, with uncomputed data, uninteresting to the final solution. In this example, the quantum circuit implementing the transformation given in eq. (1.4) is shown in FIG. 2A. The procedure implemented by the circuit of FIG. 2A can be represented with the following four steps.
Step 1—Load Data Representing the First Column of the DVR Matrix into a Quantum Computer Using a Quantum Random Access Memory

$${{{{{U}_{0} \vert p 〉 \vert q 〉 \vert x 〉 \vert 0 〉}_{g} \vert 0 〉}_{u} = \vert p 〉 \vert q 〉 \vert x 〉 \vert {T}_{p 0} ( x ) 〉}_{g} \vert 0 〉}_{u} \qquad ( 1.5 )$$

In particular, a quantum random access memory (QRAM) used in the implementation of the U_0 transformation given in eq. (1.5). N is the number of arguments (x), distributed over n qubits. \beta_x is the number of bits representing T_pq, i.e. the output of the QRAM oracle D(x). U_0 can be implemented in two parts (see e.g., FIG. 2B). First QRAM is used to load the x_p DVR grid points to a register, expressed as:

$${D}_{N , β} ( x ) \vert p 〉 \vert 0 〉 , = \vert p 〉 \vert {x}_{p} 〉 . \qquad ( 1.5 a )$$

Next another QRAM (D_{N,beta}(T_0) is used to produce the first column of the DVR matrix. The “cost” implementing eqs. (1.5, 1.5a) is the cost of QRAM and equals [symbol] (N) Toffoli gates and only 2β qubits.
Step 2—Perform First Recursive Step Implement a transformation controlled on the value of column index q, that loads the matrix elements of the second column of the DVR matrix, as shown in FIG. 2C, which implements the U_1 unitary given in eq. (1.6) below.

$${{{{{U}_{1} \vert p 〉 \vert q 〉 \vert x 〉 \vert t 〉}_{g} \vert 0 〉}_{u} = \vert p 〉 \vert q 〉 \vert x 〉 \vert t 〉}_{g} \vert {T}_{p 1} ( x ) 〉}_{u} \qquad ( 1.6 )$$

### Step 3—Perform a Sequence of Arithmetic Operations U_c

FIG. 2D presents a circuit representation of the recursive operation U_c generating columns of the DVR matrix for even values of index c; FIG. 2E presents a circuit representation of the recursive operation U_c generating columns of the DVR matrix for odd values of index c. |a> denotes |0> or 1> depending on the value of index q (see FIG. 2A).

The cost of performing any of the circuits in FIGS. 2D and 2E consist of: 1) the cost of multiplying two arbitrary numbers Cₘᵤₗ(x, t)=2β², 2) the cost of multiplying an arbitrary number represented on 2β+1 bits by another number represented on beta bits Cₘᵤₗ(α_{c},xt)=2β²+β, 3) the cost of addition C_{add}(α_{c}xt, v)= [symbol] (β). The total cost is thus is sum of costs given in steps 1)-3)+the cost of uncomputation of arithmetic registers C_{unc.}==4β², which scales as C_{U}_{_{c}}=8β²+ [symbol] (β).

### Step 4—Dump the Result to a Given Register, Controlled on the Parity of Index q

FIG. 2F presents a circuit representation of eq. (1.7) below:

$${{{V \vert p 〉 \vert q 〉 \vert x 〉 \vert t 〉}_{g} \vert v 〉}_{u} \vert z 〉}_{r} = \{ \begin{matrix}{{{\vert p 〉 \vert α 〉 \vert x 〉 \vert t 〉}_{g} \vert v 〉}_{u} \vert z ⊕ v 〉}_{r} & q \text{} mod \text{} 2 ≡ 1 \\ {{{\vert p 〉 \vert α 〉 \vert x 〉 \vert t 〉}_{g} \vert v 〉}_{u} \vert z ⊕ t 〉}_{r} & q \text{} mod \text{} 2 ≡ 0\end{matrix} , \qquad ( 1.7 )$$

Operation V dumps the result to an output register controlled on parity of the column of the DVR matrix. Pi(q) represents control on the least significant bit of q, i.e. performs parity check. The cost of operation V shown in FIG. 2F equals 2β Toffoli gates.

Furthermore, Steps 1-4 performed for c=2, . . . , K=<N−1 result in the following transformation:

$$\hat{T} = V {{\prod }^{K - 1}}_{C = 0} {U}_{C} \qquad ( 1.8 )$$

The total cost of implementing the DVR oracle is given as:

$$C ( \hat{T} ) = 2 N ( {C}_{{U}_{c}} + 2 n ) + 2 β \qquad ( 1.9 )$$

Where 2n comes from comparisons between integer indices q and c shown in FIG. 1. The total cost of implementing the T transformation given in eq. 1.9 is thus [symbol] (Nβ²). The basic algorithm we used to multiply two numbers a, b is the following. Let a and b be m-bit and m′-bit numbers respectively. The result will be written on an addition register composed of m+m′+1 qubits. This addition register is initialized in the |0> state. Next, the controlled-adder (which can be called a “bit-by-bit adder”) is executed m-times: the i-th adder Aᵢ is controlled on

$${a}_{i} ( a = \sum ( {a}_{i} {2}^{i} )$$

$$for$$

$$i = 0 , … , m - 1$$

and it adds 2ⁱb to the result register. As a result we add b on qubits from i+1 st to i+m′+1st.

The cost of the controlled adder is 2m′ Toffoli gates and thus the cost of multiplication equals 2 mm′ Toffoli gates. In a special case of multiplication by a fixed number the multiplication operation is cheaper, because adders are controlled on classical bits. If a is fixed, the multiplication costs m′-times the number of ones in the binary representation of a. The operation of multiplication Multₓ|a [symbol] =|xa [symbol] is possible in the following sense: If x is m-bit (x≠0) and a is m′-bit number then we can do: Multₓ|a [symbol] ₘ|0 [symbol] _{m′+1}=|xa [symbol] _{m″}. Note that we need m′ additional ancillas. If |x|≠1 we can't just get an approximation of xa by skipping some bits. This is because Multₓ as a unitary must be injective. Thus for x=2^{-m} we need the precision to be at least 2^{-(m+m′)}. Thus if we have N multiplications as in our construction we need [symbol] (Nm) additional ancillas. This is a reason to normalize the recurrence relation given in eq. 1.2: to save on the number of qubits.

In a further example, the DVR matrix is based on the Gauss-Hermite quadrature, widely used to integrate bosonic systems. Matrix elements of the DVR transformation are based on Gauss-Hermite quadrature satisfy the following relation:

$${T}_{pq + 2} ( x ) = x {α}_{q + 2} {T}_{pq + 1} ( x ) + {ϕ}_{q + 2} {T}_{pq} ( x ) \qquad ( 2.1 )$$

where

$${α}_{q} = \sqrt{\frac{2}{q}}$$

$$and$$

$${ϕ}_{q} = - \sqrt{\frac{q - 1}{q}} .$$

The recurrence relation given in eq. (2.1) can be normalized as demonstrated in eq. (1.2) such that

$$\vert {γ}_{q} \vert = \sqrt{\frac{q !!}{( q - 1 ) !!}} \qquad ( 2.2 )$$

which can be further rewritten as:

$$and \qquad ( 2.3 )$$

$$\sqrt{\frac{{2}^{q} {( \frac{q}{2} ! )}^{2}}{q !}} = {( \frac{( \begin{matrix}q \\ q / 2\end{matrix} )}{{2}^{q}} )}^{− 1 / 2} ∼ {( π q )}^{1 / 4}$$

$$if q is even$$

$$\sqrt{\frac{q !}{{2}^{q − 1} {( \frac{q − 1}{2} ! )}^{2}}} = {( q \frac{( \begin{matrix}q − 1 \\ ( q - 1 ) / 2\end{matrix} )}{{2}^{q − 1}} )}^{1 / 2} ∼ {( {q}^{2} / ( π ( q - 1 ) ) )}^{1 / 4} \qquad ( 2.4 )$$

$$if q is odd$$

giving:

$${T}_{pq + 2}^{′} = {( - 1 )}^{q + 1} \sqrt{2} x \frac{q !!}{( q + 1 ) !!} {T}_{pq + 1}^{′} + {T}_{pq}^{′} = {( - 1 )}^{q + 1} \sqrt{2} x {γ}_{q + 1}^{- 2} {T}_{pq + 1}^{′} + {T}_{pq}^{′} \qquad ( 2.5 )$$

The numbers represented by γ_{q} are loaded as a data-lookup table via QRAM. The main cost of implementing T_{pq}(x) as given in eq. (2.1) is the cost of U_c (see e.g., FIGS. 2D & 2E). An implementation of U_c requires multiplication of x,

$$Γ \vert q 〉 \vert a 〉 \vert 0 〉 = \vert q 〉 \vert a 〉 \vert {γ}_{q}^{- 1} a 〉 ,$$

and number v (or t), as shown in FIGS. 2D & 2E. Finally, the cost of implementing F given in eq. (1.3) equals the cost of the oracle

$${( - 1 )}^{c + 1} \sqrt{2} {γ}_{c - 1}^{2}$$

requiring loading N numbers+cost of single multiplication. Thus implementing Γ amounts to executing [symbol] (Nβ+β²) Toffoli gates.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A quantum oracle, configured to implement a discrete-variable representation (DVR) matrix, the quantum oracle comprising:
a quantum random access memory oracle configured to load a first column of the DVR matrix;
an alternating sequence of unitary circuits operating on a first set of qubits and a second set of qubits controlled via a column index configured to recursively load an additional N−1 columns of the DVR matrix; and
a quantum register controlled by a parity of the column index configured to loads states of the first set of qubits and the second set of qubits.

2. The quantum oracle of claim 1, wherein the DVR matrix is based on a Gauss-Hermite quadrature, a Laguerre quadrature, a Jacobi quadrature, Legendre quadrature or a Chebyschev quadrature of the first kind.

3. The quantum oracle of claim 1, wherein the alternating sequence of unitary circuits include first unitary circuits for odd values of the column index.

4. The quantum oracle of claim 3, wherein the alternating sequence of unitary circuits include second unitary circuits for even values of the column index that differ from the first unitary circuits.

5. The quantum oracle of claim 1, wherein the alternating sequence of unitary circuits perform a sequence of arithmetic unitary operations.

6. The quantum oracle of claim 5, wherein the alternating sequence of unitary circuits perform the sequence of arithmetic unitary operations via a corresponding sequence of recursion steps.

7. The quantum oracle of claim 6, wherein the alternating sequence of unitary circuits perform the sequence of arithmetic unitary operations without quantum-Fourier transforms.

8. The quantum oracle of claim 6, wherein the alternating sequence of unitary circuits perform the sequence of arithmetic unitary operations with via bit-by-bit adders.

9. The quantum oracle of claim 1, wherein the DVR matrix corresponds to a transformation matrix T.

10. The quantum oracle of claim 1, wherein the transformation matrix T transitions from a finite-basis representation to the discrete-variable representation.

11. A method for use with a quantum oracle configured to implement a discrete-variable representation (DVR) matrix, the method comprising:
loading a first column of the DVR matrix via a quantum random access memory oracle;
recursively loading an additional N−1 columns of the DVR matrix via an alternating sequence of unitary circuits operating on a first set of qubits and a second set of qubits controlled via a column index; and
transferring states of the first set of qubits and the second set of qubits to a quantum register controlled by a parity of the column index.

12. The method of claim 11, wherein the DVR matrix is based on a Gauss-Hermite quadrature, a Laguerre quadrature, a Jacobi quadrature, Legendre quadrature or a Chebyschev quadrature of the first kind.

13. The method of claim 11, wherein the alternating sequence of unitary circuits include first unitary circuits for odd values of the column index.

14. The method of claim 13, wherein the alternating sequence of unitary circuits include second unitary circuits for even values of the column index that differ from the first unitary circuits.

15. The method of claim 11, wherein the alternating sequence of unitary circuits perform a sequence of arithmetic unitary operations.

16. The method of claim 15, wherein the alternating sequence of unitary circuits perform the sequence of arithmetic unitary operations via a corresponding sequence of recursion steps.

17. The method of claim 16, wherein the alternating sequence of unitary circuits perform the sequence of arithmetic unitary operations without quantum-Fourier transforms.

18. The method of claim 16, wherein the alternating sequence of unitary circuits perform the sequence of arithmetic unitary operations with via bit-by-bit adders.

19. The method of claim 11, wherein the DVR matrix corresponds to a transformation matrix T.

20. The method of claim 19, wherein the transformation matrix T transitions from a finite-basis representation to the discrete-variable representation.

21. The method of claim 11, wherein the quantum oracle is utilized to construct a unitary circuit transforming a finite-basis representation to the discrete-variable representation.
